(19) United States
(12) Patent Application Publication
(10) Pub. No.: US 2016/0163232 A1
(43) Pub. Date: Jun. 9, 2016

(54) THREE-DIMENSIONAL PATTERN LABEL FILM AND MANUFACTURING METHOD THEREOF

(71) Applicant: TZU-CHIN HUNG, NEW TAIPEI CITY 249 (TW)

(72) Inventor: TZU-CHIN HUNG, NEW TAIPEI CITY 249 (TW)

(21) Appl. No.: 14/560,734

(22) Filed: Dec. 4, 2014

(51) Int. Cl. G09F 3/02; B05D 3/00; B05D 3/12; B05D 1/28

(52) U.S. Cl. CPC G09F 3/02; B05D 1/28; B05D 3/007; B05D 3/12; G09F 2003/0257; G09F 2003/0208

(57) ABSTRACT

Disclosed are a three-dimensional pattern label film and a manufacturing method thereof, in which a printing ink is formed of a mixture of resin having a volume ratio of 25-35%, foaming powder having a volume ratio of 30-40% and a particle size of 10-20 micrometers, and a mixing solvent having a volume ratio of 25-35% and is subjected to a process of gravure printing to have at least one display pattern of one of a figure, a text, and a symbol printed and thus attached to a surface of a single-layered label film base to allow the display pattern to foam on the surface of the single-layered label film base to form at least one three-dimensional patter layer having a height of 0.5 to 2 millimeter, which is then subjected to slitting, adhering, and cutting to form a label film having a three-dimensional pattern.

### BACKGROUND OF THE INVENTION

1. Field of the Invention

The present invention relates to a labeling film, which is applicable to a heat-shrinkage package label film and uses a printing ink that features bubbling and heat shrinkage to increase a height of a pattern printed so as to provide a three-dimensional pattern on a surface of a single-layer label film, and a manufacturing method thereof.

2. The Related Arts

A heat shrinkage label film has been widely used in applications of heat shrinkage packaging of a packaged article, particularly being used as an external package for consumer products, such as foods, beverages, optical disks, and books, and industrial products. With the general consumers' increasing demands for quality and perception of visual appearance of a package of a product, the dull and boring visual presentation of printing made on a surface of a conventional label film no longer satisfies the needs of the general consumers. The conventional label film must be subjected to a heat shrinkage operation in a wide range of a high temperature (90-150° C.) or a medium to high temperature (50-150° C.) to make the label film shrunk with the heat over an external of an object to be packaged. Thickening the ink printed or attaching an advertisement stick having a three-dimensional pattern to a surface of the label film are both labor- and time-consuming solutions that may increase the manufacturing cost and shows no advantages of economic effect and industrial use. For example, a conventional label film is printed in such a manner as to thicken the printed ink in order to achieve perception of a three-dimensional structure of the printed pattern; however, the ink may excessively penetrate through the surface of the label film so that when the label film is subjected to heat shrinkage, instead of being raised to show a three-dimensional form, the pattern that is printed with the ink becomes recessed or aggregate together, making it not possible to achieve the desired result of printing for a three-dimensional pattern. This is an issue to be overcome for the known label film products.

Prior art patent document are known, such as Taiwan Patent Laid-Open Gazette Publication No. 200524971, which discloses a heat-shrinkable formed film, wherein the composition of the entirety of a label film is formulated to form a unique foamed film that has a multi-layered structure. Such a known technique allows the entirety of the label film to foam and the entire label film so foamed can be used to wrap around an external of an object, rather than providing a label film that shows a three-dimensional pattern thereon. Further, the manufacturing process is complicated and costly, making it not applicable to the heat-shrinkage label films formed of various known and existing materials. Further, the multi-layered formed film structure of the prior art document can bear a very limited range of temperature of a heat shrinkage operation due to the difference of heat shrinkage rate or thermal expansion effect among the layers. For example, page 49 of the disclosure of the prior art document describes the multi-layered foamed film can only be used in a heat shrinkage operation at a temperature lower than 80° C. for a better performance as a three-dimensional foamed package for an aluminum-made can or bottle. It is not possible for the technique of the prior art document to be used in an environment where a heat shrinkage oven is often operated at a high temperature of 90-150° C. and this limits the application thereof.

Further, Japanese laid-open publication JP2004-302125 discloses a formed heat shrinkable label and a method for foaming thereof. Similarly, a multi-layered film structure is suggested. For example, paragraph [0018] and FIG. 3 of the disclosure of the prior art document illustrate an expandable heat shrinkage label film (1) that comprises, on an outside surface of a label base material (11), a foaming ink layer (12) and an external covering layer (13) are sequentially stacked on the label base material (11) and, on an inside surface of the label base material (11), gravure printing is applied to sequentially stack a color ink layer (14) and a white ink layer (15). The color ink layer (14) can be designed to provide texts and symbols. Further, the foaming ink layer 12 must be further processed with gravure printing. As described in paragraph [0023] of the disclosure of the prior art document, to make such a multi-layered film structure, in addition to the obvious drawbacks that the multi-layered structure is hard to make and the cost is high, in designing a three-dimensional pattern, the foaming ink layer (12), the color ink layer (14), and the white ink layer (15) must be designed individually and printed separately. In other words, multiple runs of printing must be performed before a tactile impression of foamed three-dimensional pattern that is consistent between inside and outside can be obtained. This takes a great amount of work hours and labor. If any one of the forming ink layer (12), the color ink layer (14), and the white ink layer (15) causes an error in the repeated performance of the gravure printing, the accuracy of the tactile impression of the surface irregularity of the color ink layer (14) and the white ink layer (15) will be affected.

Further, the label base material (11) of the Japanese prior art document must be limited to a polyester resin of polyethylene terephthalate (PET) and styrene (including copolymers) and styrol resin, such as butadiene copolymers, and polypropylene resins. For example, the Japanese prior art document describes in paragraph [0019] of the disclosure thereof that the heat shrinkage rate of the label base material (11) is measured by soaking the label base material (11) in hot water of 80° C. for 10 seconds. In other words, manufacture must be carried out in a condition that suits the need of the foaming ink layer (12) that is not resistant to an operation condition of high temperature and high-temperature drying airflows.

In addition, the Japanese prior art document must handle another issue that the foaming ink layer (12) needs an external covering layer (13) for protection. This is because the foaming ink layer (12) is not resistant to an operation condition of high temperature and high-temperature drying airflows. For example, the Japanese prior art document describes in paragraphs [0026] and [0029] of the disclosure thereof, the expandable heat shrinkage label film (1) of the Japanese prior art document must be used in a heat shrinkage operation environment where the operation is carried out a specific steam channel having a relatively low temperature of 75-90° C. If the temperature exceeds 90° C., the foaming ink layer (12) may readily peels off the label base material (11) and no sufficient wear resistance can be ensured. For a heat shrinkage operation temperature lower than 75° C., the foamability of the foaming ink layer (12) deteriorates, making it not possible to obtain desired tactile impression. Such a range of heat shrinkage operation temperature can only be achieved with a specifically designed steam heating heat shrinkage machine, making it not possible to be used in heat shrinkage packaging carried out in existing heat shrinkage machines that are generally operated in a high temperature range of 90-150° C. or a medium to high temperature range of 50-150° C. of a wide-range high-temperature operation environment that is generally dry. This limits the economic advantages and industrial use thereof.

### SUMMARY OF THE INVENTION

The primary object of the present invention is to provide a three-dimensional pattern label film and a manufacturing method thereof in order to overcome the problem that a heat shrinkage label film of the prior art or disclosed in a prior art document is not fit to the operation conditions of an existing heat shrinkage process or can only be used under severe and specific operation condition of heat shrinkage to display a three-dimensional pattern on a surface of a heat shrinkage label film.

Thus, the present invention provides a three-dimensional pattern label film, which comprises:

a single-layered label film base; and

at least one three-dimensional patter layer, which is formed of a printing ink comprising a mixture of resin having a volume ratio of 25-35%, foaming powder having a volume ratio of 30-40% and a particle size of 10-20 micrometers, and a mixing solvent having a volume ratio of 25-35%, where the printing ink forms, through gravure printing, at least one display pattern of one of a figure, a text, and a symbol on a surface of the single-layered label film base and the printing ink of the display pattern printed on and attached to the surface of the single-layered label film base is foamed to form the three-dimensional patter layer having a height of 0.5 to 2 millimeters.

In the above-described three-dimensional pattern label film of the present invention, the single-layered label film base is formed of a single layer film material of one of polyvinyl chloride (PVC), oriented polystyrene (OPS), polyethylene terephthalate glycol-modified (PET-G), polylactic acid (PLA), biaxially oriented polypropylene (BOPP), polyolefin (POE), non-oriented casting polypropylene (CPP), and oriented polypropylene (OPP).

In the above-described three-dimensional pattern label film of the present invention, the resin of the printing ink of the three-dimensional patter layer comprises acrylic resin.

In the above-described three-dimensional pattern label film of the present invention, the foaming powder of the printing ink of the three-dimensional patter layer comprises a microparticle foaming agent.

In the above-described three-dimensional pattern label film of the present invention, the mixing solvent of the printing ink of the three-dimensional patter layer is formed by mixing toluene, isopropyl alcohol, and ethyl acetate.

In the above-described three-dimensional pattern label film of the present invention, the mixing solvent of the printing ink of the three-dimensional patter layer is formed by mixing toluene, isopropyl alcohol, ethyl acetate, and butanone.

The present invention also provides a manufacturing method of a three-dimensional pattern label film, which comprises the following steps:

(a) preparing printing ink, in which a printing ink is selected as one comprising a mixture of resin having a volume ratio of 25-35%, foaming powder having a volume ratio of 30-40% and a particle size of 10-20 micrometers, and a mixing solvent having a volume ratio of 25-35%;

(b) gravure printing, in which the printing ink prepared in step (a) is guided into a gravure printing machine to carry out gravure printing to print and attach at least one display pattern of one of a figure, a text, and a symbol on a surface of a single-layered label film base;

(c) foaming to form a three-dimensional patter layer, in which the display pattern printed on the single-layered label film base in step (b) is placed still in room temperature for a time period within around one minute to allow the printing ink of the display pattern to foam and thus form at least one three-dimensional patter layer having a height of around 0.5-2 millimeters;

(d) slitting, in which the single-layered label film base on which the three-dimensional patter layer is formed through foaming in step (c) is subjected to slitting by a slitting machine to form a plurality of label film strips;

(e) adhering, in which each of the label film strips formed through slitting in step (d) is subjected to adhering of opposite ends thereof together; and

(f) cutting, in which each of the label film strips that has been adhered end to end in step (e) is subjected to cutting to form a three-dimensional pattern label film having a three-dimensional patter layer.

The effectiveness of the three-dimensional pattern label film and the manufacturing method thereof according to the present invention is that a printing ink that is formed by mixing resin having a volume ratio of 25-35%, foaming powder having a volume ratio of 30-40% and a particle size of 10-20 micrometers, and a mixing solvent having a volume ratio of 25-35% can be printed and securely attached to a single-layered label film base without penetrating into and damaging the single-layered label film base so as to be applicable to surfaces of commercially available heat shrinkage label films of various materials and not need to be used in combination with a multi-layered label film formed of special materials as suggested in the above-discussed prior art documents thereby greatly saving the manufacturing time, labor, and cost of a label film product. Further, the printing ink can foam on the surface of the single-layered label film base to form a three-dimensional pattern layer and is then applicable in a heat shrinkage operation environment for high temperature heat shrinkage and middle to high temperature heat shrinkage conducted in an existing high-temperature hot airflow drying type or steam type heat shrinkage oven with a resistance against a high temperature as high as 90-150° C. The heat shrinkage operation temperature range can also be within a wide operation temperature range of 50-150° C. With the heat shrinkage package wraps an object to be packaged, the height of the three-dimensional pattern may be further increased, on average, by 0.001-0.03 millimeters to more prominently provide the perception of three-dimensional pattern and the hand tactile impression thereby greatly improve the perception of three-dimensional pattern and the hand tactile impression of the package patterns on the outside of the object packaged. Compared to the known heat shrinkage package film discussed in the prior art documents, an apparent enhancement of the performance and a further improvement of the application range and industrial value of a heat shrinkage label film product can be achieved.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a three-dimensional pattern label film according to the present invention;

FIG. 2 is a cross-sectional view taken along line X-X′ of the three-dimensional pattern label film of the present invention, illustrating the formation of a single-layered label film base material;

FIG. 3 is a flow chart illustrating a manufacturing method of the three-dimensional pattern label film according to the present invention;

FIG. 4 is a perspective view showing the three-dimensional pattern label film according to the present invention in a condition after gravure printing;

FIG. 5 is a schematic view illustrating slitting of the three-dimensional pattern label film according to the present invention;

FIG. 6 is a schematic view illustrating adhering of the three-dimensional pattern label film according to the present invention;

FIG. 7 is a perspective view showing a first application of the three-dimensional pattern label film according to the present invention;

FIG. 8 is a perspective view showing a condition that the three-dimensional pattern label film of FIG. 7 is fit outside a bottle-like object;

FIG. 9 is a perspective view showing a second application of the three-dimensional pattern label film according to the present invention n; and

FIG. 10 is a perspective view showing a third application of the three-dimensional pattern label film according to the present invention.

### DETAILED DESCRIPTION OF THE PREFERRED EMBODIMENTS

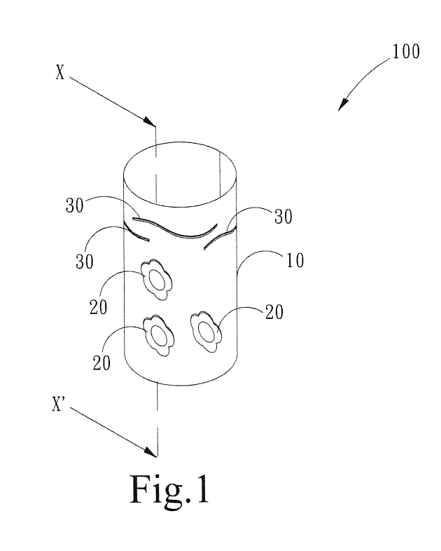

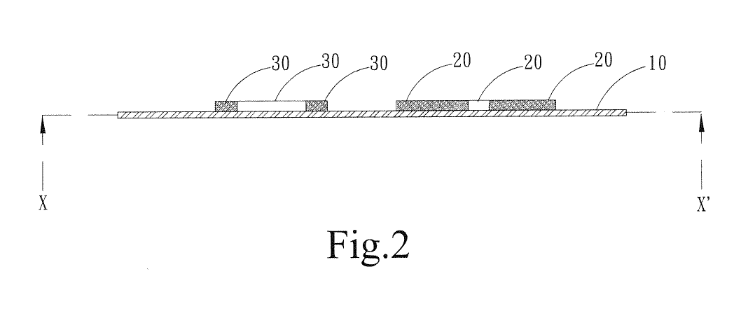

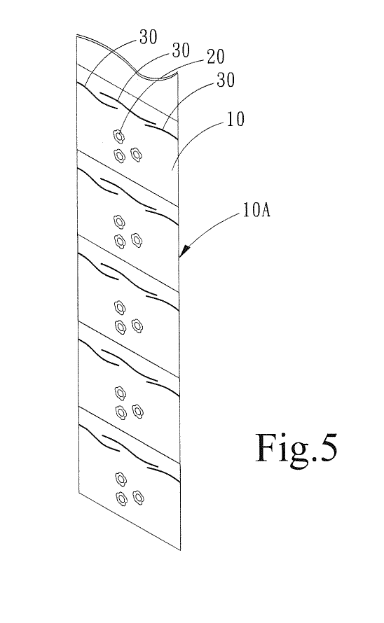

With reference to the drawings and in particular to FIGS. 1 and 2, the present invention provides a three-dimensional pattern label film 100, which comprises a single-layered label film base 10, wherein the single-layered label film base 10 can be formed of a single layer film material of for example polyvinyl chloride (PVC), oriented polystyrene (OPS), polyethylene terephthalate glycol-modified (PET-G), polylactic acid (PLA), biaxially oriented polypropylene (BOPP), polyolefin (POF), non-oriented casting polypropylene (CPP), or oriented polypropylene (OPP), at least one three-dimensional patter layer 20, 30, which is formed of a printing ink comprising a mixture of resin having a volume ratio of 25-35%, foaming powder having a volume ratio of 30-40% and a particle size of 10-20 micrometers, and a mixing solvent having a volume ratio of 25-35%, wherein the resin can be acrylic resin, the foaming powder can be a microparticle foaming agent, the mixing solvent can be a mixture of toluene, isopropyl alcohol, and ethyl acetate or a mixture of toluene, isopropyl alcohol, ethyl acetate, and butanone, where the printing ink is used to print and attach, through gravure printing, at least one display pattern 20′, 30′ (as shown in FIG. 5), such as a figure, a text, and a symbol, on a surface of the single-layered label film base 10 and the printing ink of the display pattern 20′, 30′ printed on the surface of the single-layered label film base 10 is foamed to form the three-dimensional patter layer 20, 30 (as shown in FIG. 2) having a height of 0.5 to 2 millimeters.

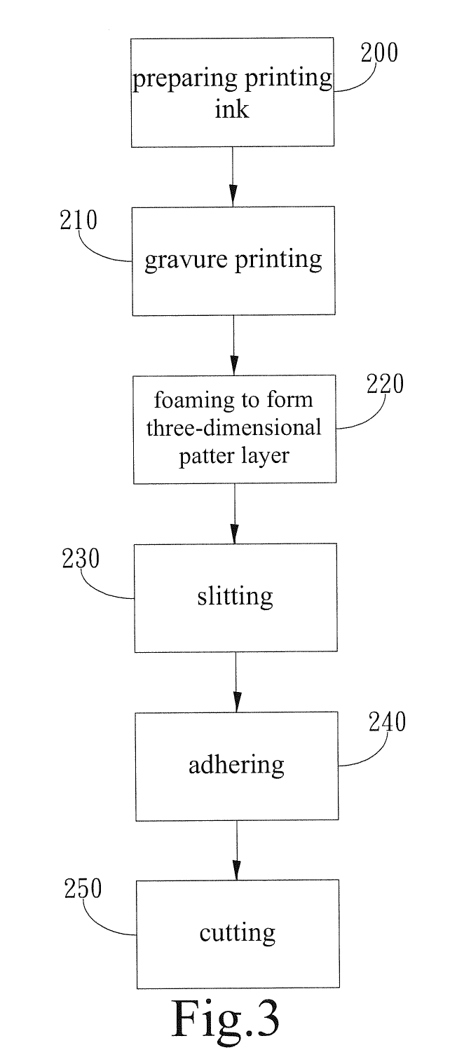

Referring also to FIG. 3, a flow chart of a manufacturing method of the three-dimensional pattern label film according to the present invention is illustrated, comprising steps 200-250, wherein:

(200) preparing printing ink, in which a printing ink is selected as one comprising a mixture of resin having a volume ratio of 25-35%, foaming powder having a volume ratio of 30-40% and a particle size of 10-20 micrometers, and a mixing solvent having a volume ratio of 25-35%;

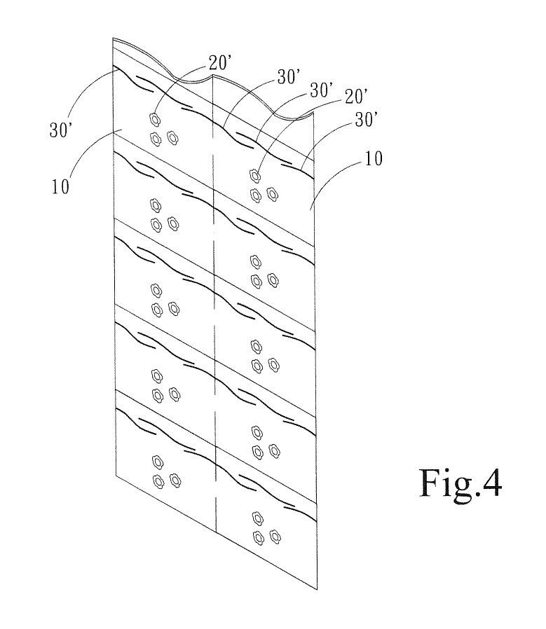

(210) gravure printing, in which, as illustrated in FIG. 4, the printing ink prepared in step 200 is guided into a gravure printing machine to carry out gravure printing to print and attach at least one display pattern 20′, 30′, such as a figure, a text, and a symbol, on a surface of a single-layered label film base 10;

(220) foaming to form a three-dimensional patter layer, in which the display pattern 20′, 30′ printed on the single-layered label film base 10 in step 210 is placed still in room temperature for a time period within around one minute to allow the printing ink of the display pattern 20′, 30′ to foam and thus form at least one three-dimensional patter layer 20, 30 (as shown in FIG. 2) having a height of around 0.5-2 millimeters;

(230) slitting, in which as shown in FIG. 5, the single-layered label film base 10 on which the three-dimensional patter layer 20, 30 is formed through foaming in step 220 is subjected to slitting by a slitting machine to form a plurality of label film strips 10A;

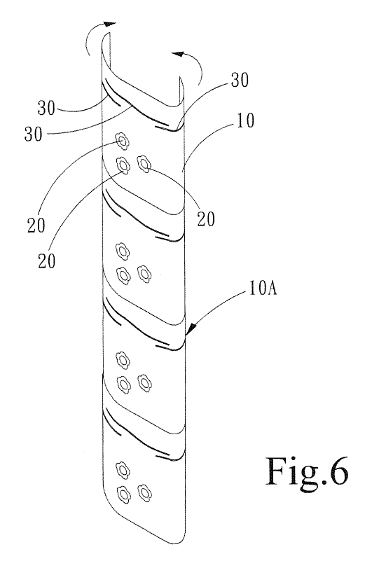

(240) adhering, in which, as shown in FIG. 6, each of the label film strips 10A formed through slitting in step 230 is subjected to adhering of opposite ends thereof together (as illustrated by arrows shown in FIG. 6); and

(250) cutting, in which each of the label film strips that has been adhered end to end in step 240 is subjected to cutting to form a three-dimensional pattern label film 100 having a three-dimensional patter layer 20, 30 as shown in FIG. 1.

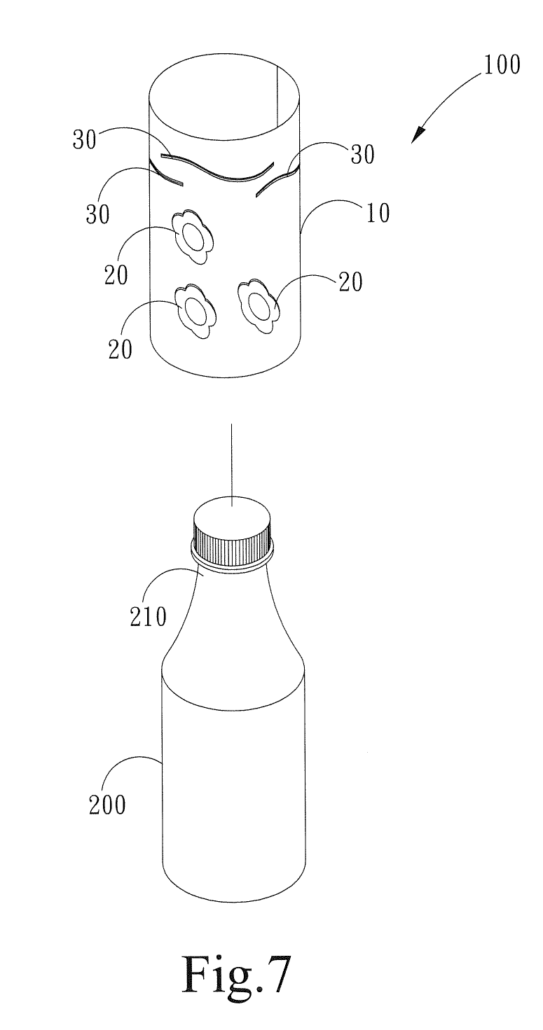

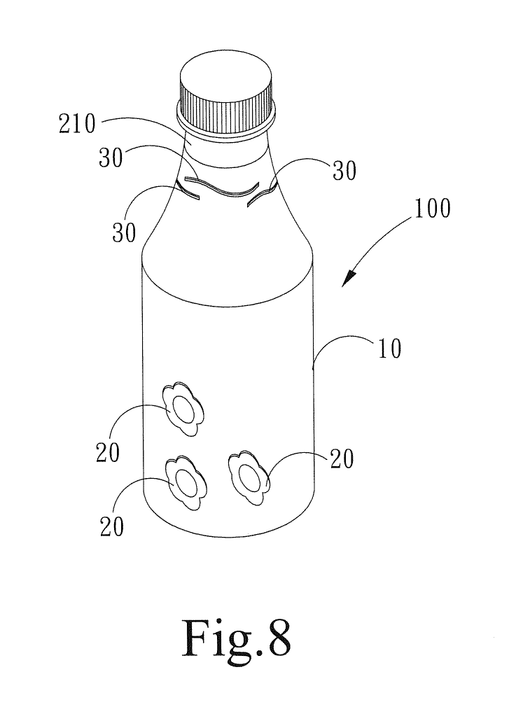

Referring to FIGS. 7 and 8, schematic views are given to illustrate a first application of the three-dimensional pattern label film 100 according to the present invention, wherein the three-dimensional pattern label film 100 is shown fit over a bottle-like object 300 and is subjected to heating by an existing hot airflow type heat shrinkage machine or an existing steam type heat shrinkage machine, which is operated at a wide operation temperature range of high temperature as high as 90-150° C. or middle to high temperature of 50-150° C., so as to have the three-dimensional pattern label film 100 shrunk to wrap the surface of the bottle-like object 300. The height of the three-dimensional patter layer 20, 30 formed on the surface of the single-layered label film base 10 may thus be further increased by around [symbol] 0.01 to 0.03 millimeters. Those portions having a shrunk diameter or a shrinkage rate, such as those close to a neck 310 of the bottle-like object 300, may show more prominent three-dimensional visual perception of the three-dimensional patter layer 30.

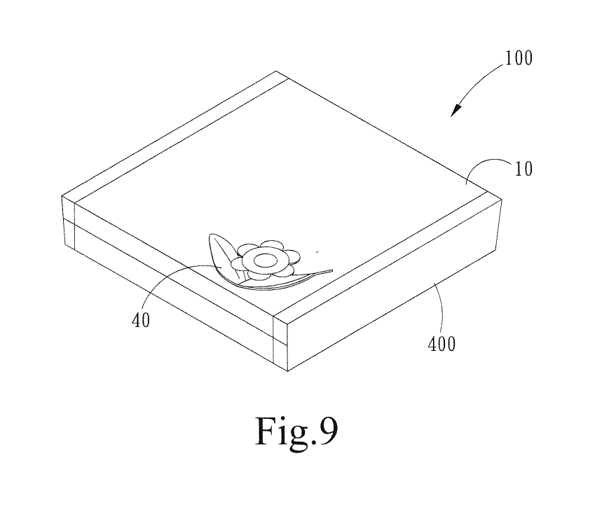

Referring to FIG. 9, a schematic view is given to illustrate a second application of the three-dimensional pattern label film 100 according to the present invention, wherein the three-dimensional pattern label film 100 is shown heat-shrunk and covering the outside of a gift 400, where the three-dimensional visual perception of a three-dimensional patter layer 40 formed on a surface of the single-layered label film base 10 can be used as a three-dimensional decoration of a surface package of the gift 400 and may substitute a ribbon decoration that is conventionally used for decorating a gift 400 and is generally not environment protecting, whereby the quality of package can be improved showing advantages for both product quality and environmental protection.

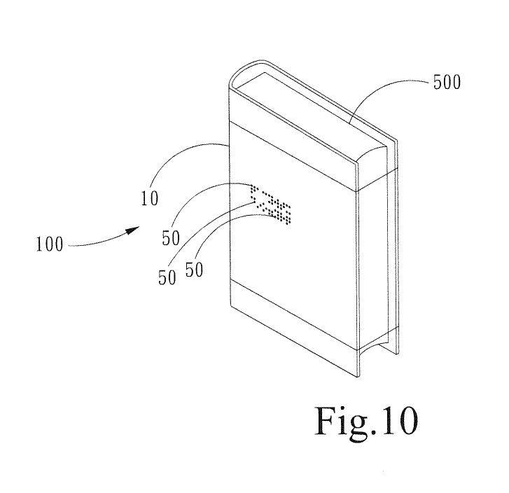

Referring to FIG. 10, a schematic view is given to illustrate a third application of the three-dimensional pattern label film 100 according to the present invention, wherein the three-dimensional pattern label film 100 is shown heat-shrunk and covering the outside of a book 500 for the blinds. The single-layered label film base 10 comprises, on a surface thereof, a plurality of three-dimensional patter layers 50 that forms Braille codes to allow a blind person or a visually impaired person to touch, with hands, the three-dimensional patter layers 50 on the surface of the single-layered label film base 10 for reading and recognizing data of the book 500, including for example price, title, classification, and author(s). This helps the blind persons or the visually impaired persons to readily identify the book 500 to be purchased or borrowed by touching the plurality of three-dimensional patter layer 50 formed on the surface of the single-layered label film base 10. As such, the application and industrial value of the three-dimensional pattern label film 100 of the present invention can be enhanced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A three-dimensional pattern label film, comprising:
a single-layered label film base; and
at least one three-dimensional patter layer, which is formed of a printing ink comprising a mixture of resin having a volume ratio of 25-35%, foaming powder having a volume ratio of 30-40% and a particle size of 10-20 micrometers, and a mixing solvent having a volume ratio of 25-35%, where the printing ink forms, through gravure printing, at least one display pattern of one of a figure, a text, and a symbol on a surface of the single-layered label film base and the printing ink of the display pattern printed on and attached to the surface of the single-layered label film base is foamed to form the three-dimensional patter layer having a height of 0.5 to 2 millimeters.

2. The three-dimensional pattern label film as claimed in claim 1, wherein the single-layered label film base is formed of a single layer film material of one of polyvinyl chloride (PVC), oriented polystyrene (OPS), polyethylene terephthalate glycol-modified (PET-G), polylactic acid (PLA), biaxially oriented polypropylene (BOPP), polyolefin (POE), non-oriented casting polypropylene (CPP), and oriented polypropylene (OPP).

3. The three-dimensional pattern label film as claimed in claim 1, wherein the resin of the printing ink of the three-dimensional patter layer comprises acrylic resin.

4. The three-dimensional pattern label film as claimed in claim 1, wherein the foaming powder of the printing ink of the three-dimensional patter layer comprises a microparticle foaming agent.

5. The three-dimensional pattern label film as claimed in claim 1, wherein the mixing solvent of the printing ink of the three-dimensional patter layer is formed by mixing toluene, isopropyl alcohol, and ethyl acetate.

6. The three-dimensional pattern label film as claimed in claim 1, wherein the mixing solvent of the printing ink of the three-dimensional patter layer is formed by mixing toluene, isopropyl alcohol, ethyl acetate, and butanone.

7. A manufacturing method of a three-dimensional pattern label film, comprising the following steps:
(A) preparing printing ink, in which a printing ink is selected as one comprising a mixture of resin having a volume ratio of 25-35%, foaming powder having a volume ratio of 30-40% and a particle size of 10-20 micrometers, and a mixing solvent having a volume ratio of 25-35%;
(B) gravure printing, in which the printing ink prepared in step (A) is guided into a gravure printing machine to carry out gravure printing to print and attach at least one display pattern of one of a figure, a text, and a symbol on a surface of a single-layered label film base;
(C) foaming to form a three-dimensional patter layer, in which the display pattern printed on the single-layered label film base in step (B) is placed still in room temperature for a time period within around one minute to allow the printing ink of the display pattern to foam and thus form at least one three-dimensional patter layer having a height of around 0.5-2 millimeters;
(D) slitting, in which the single-layered label film base on which the three-dimensional patter layer is formed through foaming in step (C) is subjected to slitting by a slitting machine to form a plurality of label film strips;
(E) adhering, in which each of the label film strips formed through slitting in step (D) is subjected to adhering of opposite ends thereof together; and
(F) cutting, in which each of the label film strips that has been adhered end to end in step (E) is subjected to cutting to form a three-dimensional pattern label film having a three-dimensional patter layer.
